(19) United States
(12) Patent Application Publication
(10) Pub. No.: US 2026/0021972 A1
(43) Pub. Date: Jan. 22, 2026

(54) CARRIER-BELT CONVEYOR WITH DIVERTER SWITCH

(71) Applicant: Laitram, L.L.C., Harahan, LA (US)

(72) Inventor: Benny J. Boudreaux, IV, Harvey, LA (US)

(21) Appl. No.: 19/102,528

(22) PCT Filed: Jul. 28, 2023
(86) PCT No.: PCT/US2023/028956

§ 371 Date: Feb. 10, 2025

Related U.S. Application Data
(60) Provisional application No. 63/407,208, filed on Sep. 16, 2022.

(51) Int. Cl. B65G 17/08; B65G 47/46; B65G 47/82

(52) U.S. Cl. CPC B65G 17/08; B65G 47/46; B65G 47/82

(57) ABSTRACT

A modular-belt conveyor for translating articles along the width of the conveyor atop carriers on the belt. The carriers have an upper article-supporting slat at the top of a belt module connected to a lower follower that extends through the thickness of the module and past its bottom. Guides in the conveyor frame in contact with the followers guide the carriers along the width of the belt in slots. A diverter switch switches the followers between two carryway guides: one defining a home path and the other, a divert path.

### BACKGROUND

The invention relates generally to power-driven conveyors and in particular to conveyors having modular belts with article-supporting carriers guided by a diverter switch to translate articles across the belts.

Article diverters, such as shoe sorters, are used to translate articles across the width of a conveyor as the conveyor transports the articles in a conveying direction. Typical shoe sorters include article-pushing elements, referred to as shoes, that are driven laterally across the conveyor to push articles off one or both sides of the conveyor or to position articles across the width of the conveyor. Slat conveyors and modular conveyor belts are used as platforms for the shoes, which ride in tracks extending across the width of the slat or belt conveyors. Typical shoes are block-or peg-shaped with depending structural elements that keep the shoes in the tracks and extend below the bottom of the belt or slat to engage carryway guide rails that control the lateral position of the shoes. Pushing shoes work well with many articles. But some articles require gentler handling on their sides. Soft articles, such as bread loaves, can be dented by pushers. And packages that enter the conveyor wide-side-leading are difficult for pusher shoes to orient because of the short package length presented to the pushers.

### SUMMARY

One version of a conveyor embodying features of the invention comprises a conveyor belt suitable for advancing along a carryway in a direction of belt travel. The conveyor belt is constructed of a series of belt rows of one or more belt modules hingedly joined end to end at hinge joints. Each of the belt rows extends in width from a first side to a second side and in thickness from a top to a bottom. At least some of the belt rows include a belt module that extends in width from a left side to a right side. A slot extends through the thickness of the belt module along its width. The conveyor also comprises a carrier having a follower that extends through the slot and past the bottom of the belt module and that has a bearing surface. A slat is attached to the follower at the top of the belt module to slide along the width of the belt row with the follower. The slat has an upper article-supporting surface and a bottom side. The slat extends along the width of the row. The conveyor also comprises an actuator and a diverter switch in the carryway under the conveyor belt. The diverter switch includes a guide portion having a first exit channel and a second exit channel oblique to the first exit channel and a shuttle defining at least a portion of an entry channel that leads to the first and second exit channels and having a gap. The actuator is coupled to the shuttle to translate the shuttle from a first position in which the gap is positioned to define a first path for the carrier's follower through the entry channel, the gap, and the first exit channel and in which shuttle structure blocks the second exit channel to a second position in which the gap is positioned to define a second path for the carrier's follower through the entry channel, the gap, and the second exit channel and in which shuttle structure blocks the first exit channel.

Another version of a conveyor comprises a carryway and a conveyor belt suitable for advancing along the carryway in a direction of belt travel. The conveyor belt comprises a series of belt rows of one or more belt modules hingedly joined end to end at hinge joints. Each of the belt rows extends in width from a first side to a second side and in thickness from a top to a bottom. At least some of the belt rows comprise a belt module that extends in width from a left side to a right side. A slot extends through the thickness of the belt module along the module's width. A carrier has a follower that extends through the slot and past the bottom of the belt module and has a follower body with an upper bearing surface and a pin extending downward from a bottom of the follower body. The pin is narrower than the rest of the follower body and is disposed at a level lower than a lowermost level of the upper bearing surface. A slat with an upper article-conveying surface is attached to the follower at the top of the belt module to slide along the width of the belt row with the follower. The slat extends along the width of the row. The conveyor also comprises an actuator and a diverter switch in the carryway under the conveyor belt. The diverter switch includes an entry portion having two side walls defining an entry channel through which the carrier's follower is guided by contact between the follower's upper bearing surface and one of the side walls, a shuttle having a gap between two walls, and a guide portion that has a first exit channel and a second exit channel oblique to the first exit channel. An upper diagonal exit guide wall bounds the second exit channel and a lower diagonal exit guide wall bounds the second exit channel closer to the shuttle's gap. The actuator is coupled to the shuttle to translate the shuttle from a first position in which the gap is positioned to define a first path for the carrier's follower through the entry channel, the gap, and the first exit channel and in which shuttle structure blocks the second exit channel to a second position in which the gap is positioned to define a second path for the carrier's follower through the entry channel, the gap, and the second exit channel and in which shuttle structure blocks the first exit channel. When the shuttle is in the second position, the follower is guided through the entry channel by contact between the upper bearing surface and one of the entry portion's side walls and one of the shuttle's walls and, after exiting the gap, by contact between the pin and the lower diagonal exit guide wall to divert the follower into the second exit channel until the upper bearing surface of the follower engages the upper diagonal exit guide wall to guide the follower the rest of the way through the second exit channel along the second path.

A diverter switch that is suitable for causing a conveyor belt's follower having an upper bearing surface and a recessed lower bearing surface to translate laterally along the width of the belt perpendicular to a direction of belt travel of the conveyor belt along an upper carryway and returning along a lower returnway comprises (a) a shuttle having a first diagonal wall and a second wall and being laterally translatable between a first position and a second position and (b) a fixed guide portion, which has first and second exit channels. The second exit channel is bounded on one side by a lower exit guide wall and an upper exit guide wall at a level above the lower exit guide wall. When the shuttle is in the second position, a conveyor-belt follower is initially guided laterally as the conveyor belt advances in a direction of belt travel by contact between an upper bearing surface of the follower and the first diagonal wall, then guided by contact between a lower bearing surface of the follower and the lower exit guide wall, and finally guided by contact between the upper bearing surface and the upper exit guide wall along the second exit channel.

### BRIEF DESCRIPTION OF THE DRAWINGS

FIG. 1 is an isometric view of a portion of a modular conveyor belt embodying features of the invention.

FIG. 2 is an exploded isometric view of a two-piece carrier for a conveyor belt as in FIG. 1.

FIG. 3 is a bottom plan view of the slat portion of the carrier of FIG. 2.

FIG. 4 is an enlarged isometric view of the follower portion of the carrier of FIG. 2.

FIG. 5 is a cross section of one row of the modular conveyor belt of FIG. 1 taken along lines V-V.

FIG. 6 is an isometric view of a one-piece carrier usable in a conveyor belt as in FIG. 1.

FIG. 7 is a top plan view of a conveyor frame for a conveyor belt as in FIG. 1.

FIG. 8 is an enlarged view of a diverter switch in the conveyor frame of FIG. 7.

FIGS. 9A and 9B are isometric and top plan views of the switch of FIG. 8 in a diverting position.

FIGS. 10A and 10B are isometric and top plan views of the switch of FIG. 8 in a home position.

FIGS. 11A-11E are top plan views of the switch of FIG. 8 showing the sequential advance of a carrier follower through the switch in a diverting position.

FIG. 12 is a top plan view of the switch of FIG. 8 guiding a worn follower.

FIGS. 13A-13D are isometric views of another version of a diverter switch showing the sequential advance of a carrier follower through the switch in a diverting position.

FIG. 14 is an exploded view of another version of a diverter switch with a return aligner usable in a conveyor as in FIG. 7.

FIG. 15 is an isometric view of the assembled switch assembly of FIG. 14.

FIG. 16 is an axonometric view of the entry and guide portions of the switch of FIG. 14 from a bottom perspective.

FIG. 17 is an isometric view of a shuttle for the switch of FIG. 14.

FIG. 18 is an isometric view of a connecting block for the switch of FIG. 14.

FIG. 19 is a bottom plan view of the switch of FIG. 15.

### DETAILED DESCRIPTION

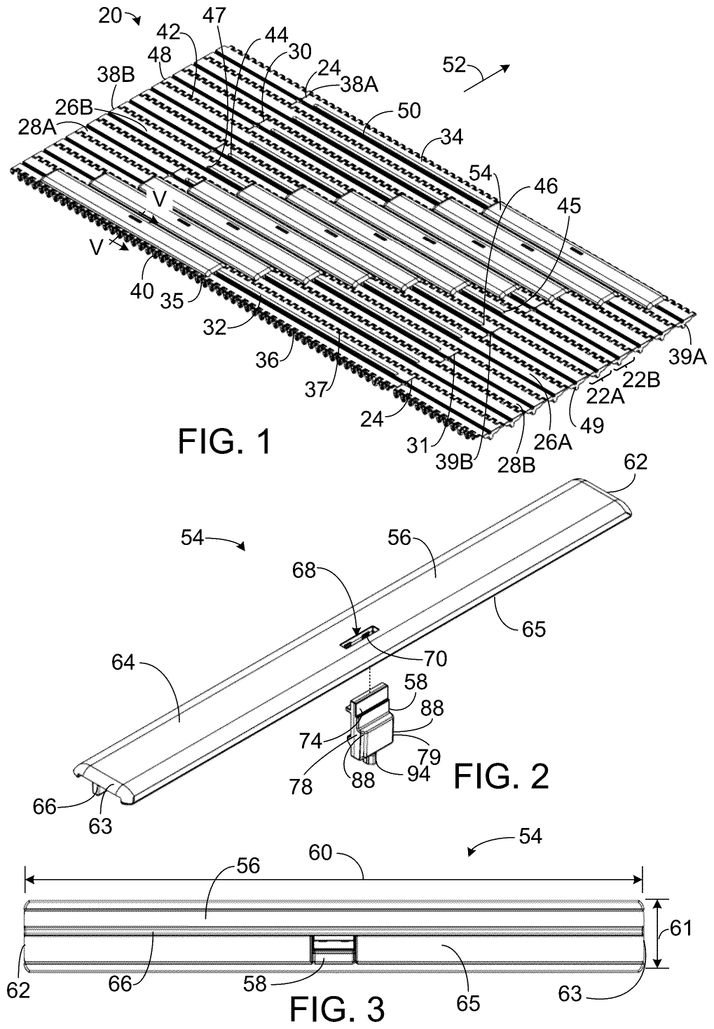

A portion of a conveyor belt embodying features of the invention is shown in FIG. 1. The belt 20 is constructed of a series of even belt rows 22A alternating with odd belt rows 22B in a bricklay pattern to avoid continuous seams 24 from row to row. In this example, the even belt rows 22A consist of a carrier module 26A beside an edge module 28A at the left side 30 of the carrier module. The odd belt rows 22B consist of a carrier module 26B beside an edge module 28B at the right side 31 of the carrier module.

The carrier modules 26A, 26B each have a slot 32 that extends through the thickness of the module body from a top 34 to a bottom 35, as is also shown in FIG. 5. The carrier module bodies extend in length from first ends 36 to second ends 37 and in width from first sides 38A, 38B to second sides 39A, 39B. First hinge elements 40 are spaced apart along the first end 36 of the module body; second hinge elements 41 are spaced apart along the second end 37. The first hinge elements 40 of a belt row are interleaved with the second hinge elements 41 of an adjacent belt row and joined by hinge rods or pins (not shown) at hinge joints 42 to form an endless modular conveyor belt 20.

The slots 32 in the carrier modules 26A in the even belt rows 22A extend partway across the width of the belt row from a first slot end 44 to a second slot end 45. The second slot end 45 is indented a greater distance inward of the right side 39A of the corner module 26A than the first slot end 44 is indented inward of the left side 38A. The slots 32 in the carrier modules 26B in the odd belt rows 22B extend partway across the width of the belt row from a first slot end 46 to a second slot end 47. The second slot end 47 is indented a greater distance inward of the left side 38B of the carrier module 26B than the first slot end 46 is indented inward of the right side 39B. The only difference between the carrier modules 26A and the carrier modules 26B is the side of the indentation. So, in other respects, a description of the one applies to the other.

The difference between the carrier modules 36A in the even rows 22A and the carrier modules 36B in the odd rows 22B allows the carrier modules to be bricklaid with edge modules 28A, 28B to avoid continuous seams from row to row. Thus, in this example, each even belt row 22A extends in width from a first side 48 defined by an edge module 28A to an opposite second side 49 defined by the side 39A of the carrier module 26A, and each odd belt row 22B extends in width from the first side 48 defined by the side 38B of the carrier module 26B to the second side 49 defined by an edge module 28B.

A groove 50 is formed in the top 34 of each carrier module 26A, 26B and each edge module 28A, 28B. The groove 50 extends parallel to the slots 32 along the widths of the carrier modules 26A, 26B and the edge modules 28A, 28B. The grooves 50 in the edge modules 28A, 28B align with and form continuations of the grooves in the carrier modules 26A, 26B in each row. Unlike the carrier modules 26A, 26B, the edge modules 28A, 28B in this example are devoid of slots 32. Thus, in each belt row 22A, 22B, the slot 32 extends a lesser distance across the width of the belt row than the groove 50. But edge modules with slots continuous with the slots 32 in the carrier modules 26A, 26B could be used. And the left ends 44, 47 of the slots 32 in the even and odd belt rows 22A, 22B are aligned in a direction of belt travel 52. Likewise, the right ends 45, 46 of the slots 32 in the even and odd belt rows 22A, 22B are aligned in the direction of belt travel 52.

A carrier 54 is mounted in each carrier module 26A, 26B to slide along the slot 32. The carrier 54, shown in more detail in FIGS. 2-4, has an upper slat 56 connected to a lower follower 58. (The follower is so-named because it follows guide surfaces beneath the belt as the belt advances, as subsequently explained in further detail.) The slat 56 is roughly rectangular in a plan view with a long dimension 60 and a short dimension 61. The long dimension 60 extends across the width of the carrier module body from a first slat end 62 to a second slat end 63. The short dimension 61 extends along the length of the carrier module body. The slat 56 has an article-supporting upper surface 64 and a bottom side 65. A rib 66 depending downward from the bottom side 65 extends from the first slat end 62 to the second slat end 63 in this version, but the rib could extend a lesser distance across the width.

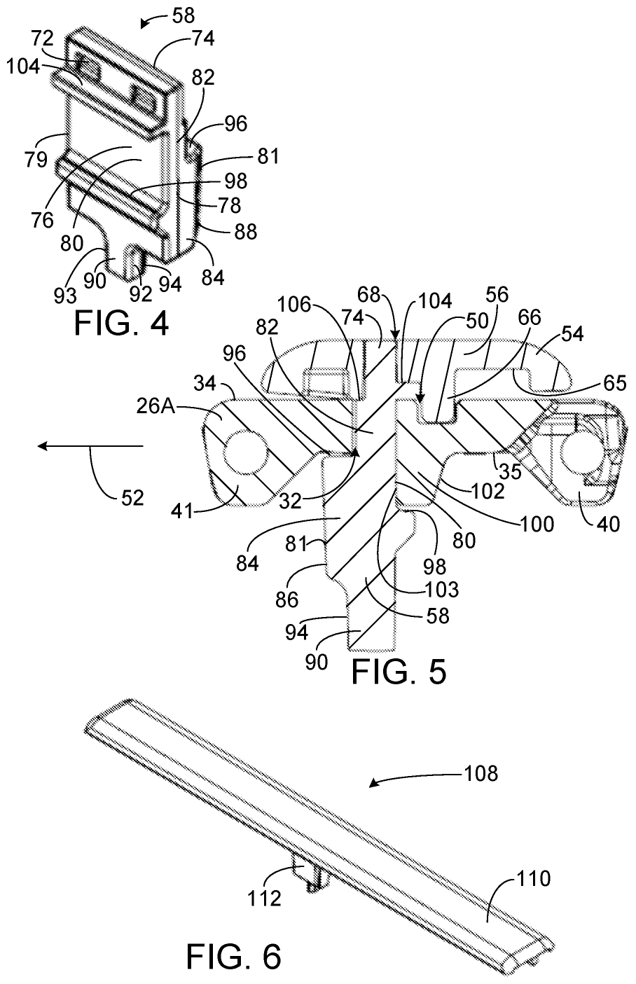

The follower 58 plugs into a socket 68 positioned in the slat 56 midway between the slat ends 62, 63 as shown in FIGS. 2 and 5. Tabs 70 in the socket 68 engage recesses 72 in a plug 74 at the top end of the follower 58 in a snap fit. (See also FIG. 4.) The follower 58 has a follower body 76 that has a body width that extends from a first side edge 78 to a second side edge 79, as best shown in FIG. 4. The follower body 76 extends perpendicular to the width from a rear side 80 to a front side 81, as also shown in FIG. 5. The front side 81 is so designated because it leads the rear side 82 in the direction of belt travel 52. A neck 82 below the plug 74 is received in the slot 32 through the carrier module body. A front boss 84 at the front side 81 of the follower 58 below the neck 82 has a front face 86 and bearing surfaces 88 extending from the front face to each of the side edges 78, 79, as also shown in FIG. 2. A pin 90 protrudes downward at the bottom of the follower body. The neck 82 and the front boss 84 extend from the first side edge 78 to the second side edge 79. The pin 90 is much narrower and has opposite side walls 92, 93 that are parallel along a rear portion and that converge to an apex 94 at the front side 81. The side walls 92, 93 are indented inward of the side edges 78, 79 of the follower body 76. Because the bearing surfaces 88 at the side edges 78, 79 are above and outward of the pin's side walls 92, 93, the bearing surfaces are referred to as upper bearing surfaces, and the pin's side walls are referred to as recessed lower bearing surfaces.

A front shelf 96 atop the front face 84 and a rear shelf 98 at the rear side 80 below the level of the front shelf extend from the first side edge 78 to the second side edge 79. The two shelves 96, 98 reside slightly below structure at the bottom 35 of the carrier module 26A on opposite sides of the slot 32. The shelves 96, 98 interfere with that module bottom structure to prevent the follower 58 from exiting the slot 32. The rear shelf 98 resides below a bar 100 that extends downward from the module bottom 35 and across the width of the carrier module 26A. The bar 100 may be a drive bar that has a rear face 102 against which a drive force is applied to push the carrier module 26A and the belt in the direction of belt travel 52. The bar 100 may alternatively or additionally serve to bolster the module against vertical impacts. The slot 32 through the carrier module 26A opens onto the bottom 35 adjacent to a front face 103 of the bar 100. As also shown in FIGS. 4 and 5, the follower 58 has an upper rear shelf 104 and an upper front shelf 106 on which the slat 56 sits for support at the lower ends of the socket 68.

The carrier 54 is installed in the carrier module 26A as follows. First, the plug 74 of the follower 58 is inserted into the socket 68 in the slat 56 and snap-fitted in place to complete the assembly of the carrier 54. Then the carrier's follower 58 is pushed into the slot 32 from the top 34 of the module 26A until the lower front and rear shelves 96, 98 clear the bottom of the slot.

FIG. 6 shows a one-piece carrier 108 in which a slat portion 110 and a follower portion 112 are unitarily formed, such as by molding, as a single piece. In other respects, the one-piece carrier 108 is identical to the two-piece carrier 54 of FIG. 2. The one-piece carrier 108 is installed in the carrier module 26A in the same way as the two-piece carrier 54.

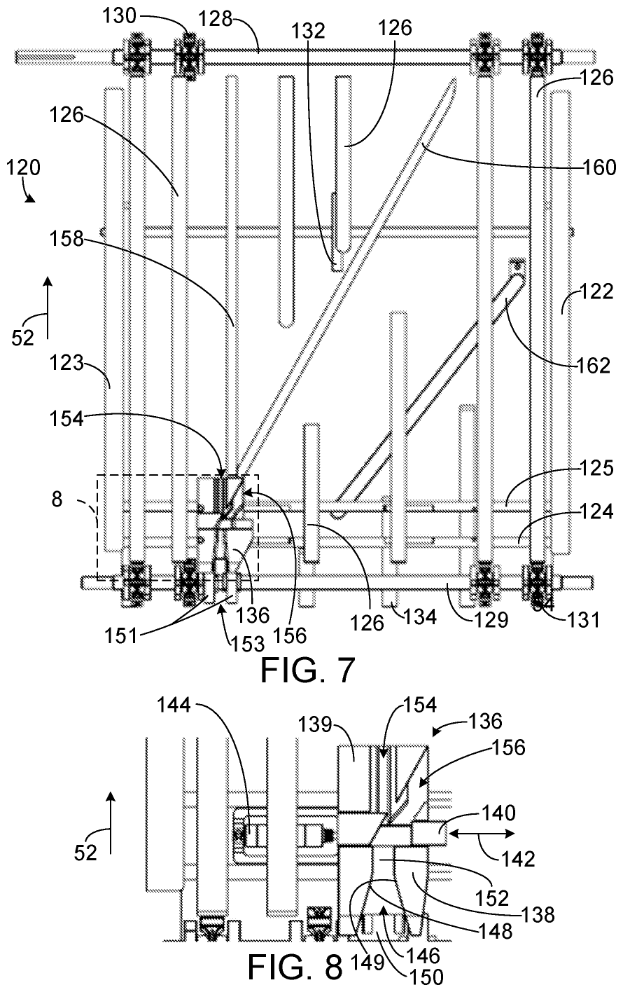

FIG. 7 shows a conveyor frame 120 for a conveyor belt 20 as in FIG. 1. The frame 120 has two frame sides 122, 123 that support the ends of cross beams 124, 125, which support carryway wearstrips 126 on which the belt rides. The frame 120 supports, at the exit of the carryway, a motor-driven shaft 128 and drive sprockets 130 that drive the belt in the direction of belt travel 52. The frame 120 also supports an idle shaft 129 and idle sprockets 131 at the carryway entrance. The belt is supported in a lower returnway on a return roller 132 and return wearstrips 134.

A diverter switch 136 is supported on the cross beams 124, 125 at a fixed position in the carryway. The diverter switch 136 has a fixed entry portion 138, a fixed guide portion 139, and a movable shuttle 140 between the entry and guide portions, as better shown in FIG. 8. As indicated by two-headed arrow 142, the shuttle 140 is translated laterally along the width of the conveyor perpendicular to the direction of belt travel 52 by a linear actuator 144 between a divert position and a home position. A programmable processor (not shown) controls the actuator 144 to selectively divert or not divert each article received by the conveyor.

The entry portion 138 of the switch 136 has an entry channel 146 with opposite side walls 148 that converge from a wide mouth 150 of the entry channel to a narrower throat 152 at the shuttle 140. The entry channel 146 extends through the shuttle 140. The wide mouth 150 increases the tolerance of the entry channel 146 so that it can receive carrier followers not precisely returned to their home positions in line with a home exit channel 154 parallel to the direction of belt travel 52. Idle rollers 151, shown in FIG. 7, are fixed in axial positions on the idle shaft 129 across an inter-roller gap 153 aligned with the switch's mouth 150. The idle rollers confine the followers to prevent them from migrating laterally across the conveyor during cleaning. The lateral position of the shuttle 140 guides the followers either straight ahead to the home exit channel 154 in the guide portion 139 of the switch 136 or obliquely to a divert exit channel 156. The home exit channel 154 is an inline exit channel because it is in line with the direction of belt travel 52 at the home position along the width of the conveyor.

As shown in FIG. 7, followers exiting the home exit channel 154 are prevented from leaving the home position by a home guide 158. Followers exiting the divert exit channel 156 are guided across the width of the conveyor 120 by a diagonal guide 160 as the belt advances along the carryway.

FIG. 1 shows the movement of the carriers 54 when their followers are diverted by the diverter switch from the home position H through the divert exit channel to a divert position D laterally spaced from the home position across the width of the conveyor. Thus, the conveyor can be operated, for example, as a 1:2 switch conveyor that receives articles on the left side and selectively conveys them atop the carriers 54 either straight ahead in a home-position lane to a first exit or diverts them toward the right to a second exit at the divert position D. FIG. 7 also shows a return guide 162 in the lower returnway that guides diverted followers back to the home position to be received by the diverter switch 136.

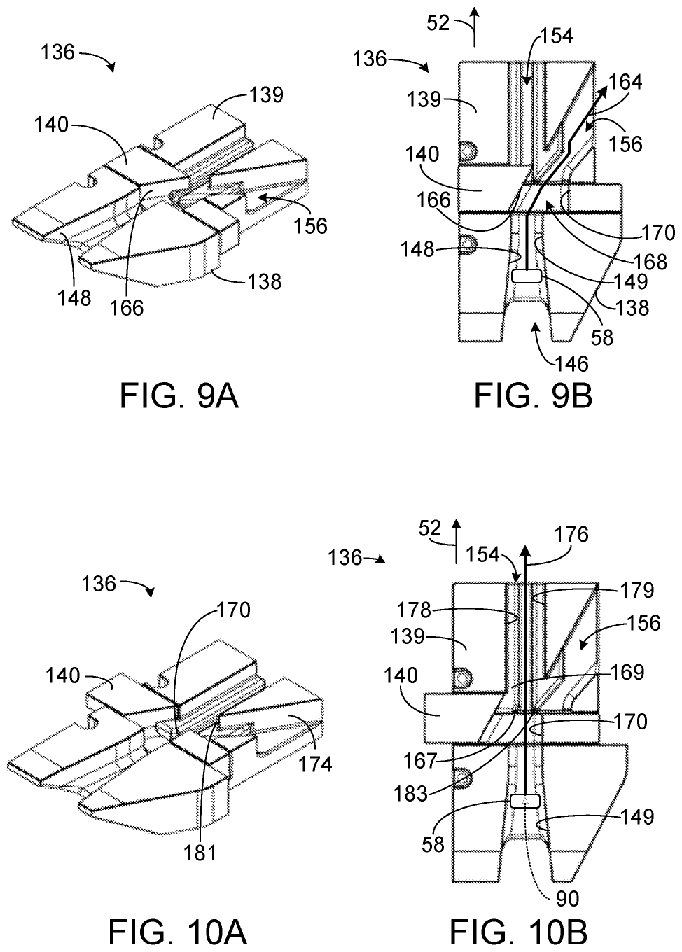

The construction of the diverter switch 136 is better shown in FIGS. 9A, 9B, 10A, and 10B. In FIGS. 9A and 9B, the switch 136 is shown in the diverting position guiding a follower 58 out through the divert exit channel 156 along a divert path 164 through the switch's guide portion 139. The shuttle 140 has a diagonal wall 166 across a gap 168 from an inline wall 170 parallel to the direction of belt travel 52. The diagonal wall 166 narrows the gap 168 toward the divert exit channel 156. In the diverting position of the switch 136, the shuttle 140 is in a right-most position with its diagonal wall 166 forming a continuation of the left-side wall 148 of the entry channel 146 in the switch's entry portion 138. The shuttle's diagonal wall 166 also blocks the home exit channel 154 and guides the follower 58 to the divert exit channel 156.

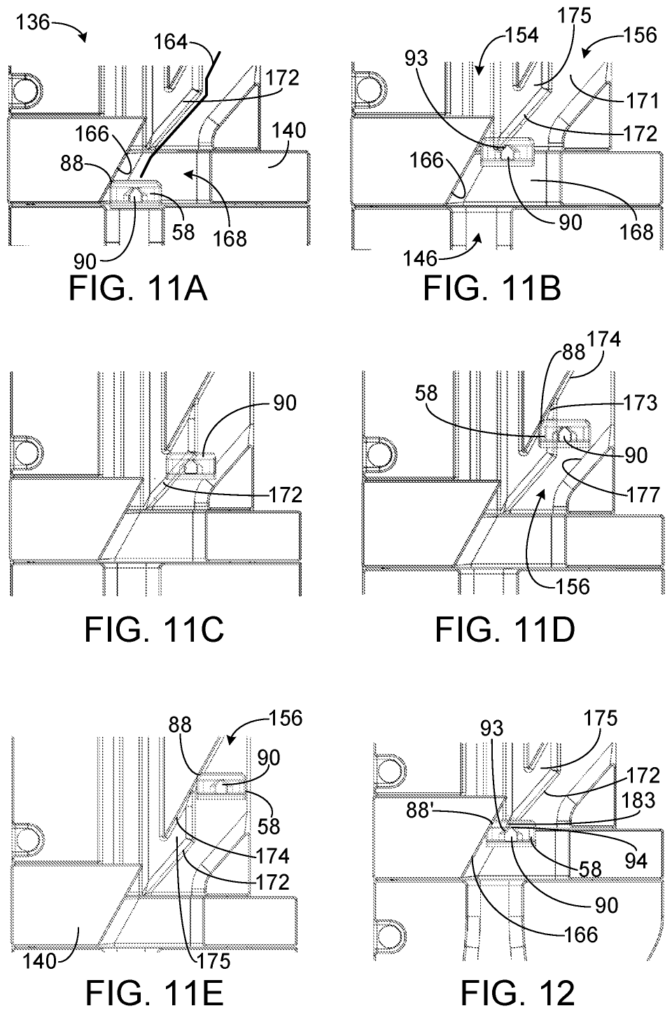

The lateral translation of the follower 58 through the diverter switch 136 in the diverting position is shown sequentially in FIGS. 11A-11E. The upper bearing surface 88 on the left side of the follower 58 is guided by the diagonal wall 166 along the divert path 164 through the gap 168 in the shuttle 140, as in FIG. 11A. The follower's pin 90 is then picked up by a lower diagonal exit guide wall 172 that contacts the tapered segment of the pin's side wall 93 as shown in FIG. 11B. The point of initial contact with the lower diagonal exit guide wall 172 depends on the wear of the upper bearing surface 88. The greater the wear of the upper bearing surface 88 and the diagonal wall 166, the farther along the lower diagonal exit guide wall 172 does the handoff of contact from the bearing surface to the pin 90 occur. Once in contact with the pin 90, the lower diagonal exit guide wall 172 continues to guide the follower 58 a short distance until the wall ends as in FIG. 11C. The pin 90 is guided by an inline lower wall segment 173 until the follower's upper bearing surface 88 is contacted by an upper diagonal exit guide wall 174, as shown in FIG. 11D. A restraining wall 177 on the opposite side of the divert exit channel 156 limits bouncing of the follower 58 caused by the handoff from the diagonal wall 166 of the shuttle 140 to the lower diagonal exit guide wall 172 and the initial contact between the follower's upper bearing surface 88 and the upper diagonal exit guide wall 174. The upper diagonal exit guide wall 174 extends down to the bottom of the divert exit channel 156 past the inline lower wall segment 173. Where the guiding is transferred from the pin 90 back to the upper bearing surface 88 depends on the bearing surface's wear. The greater the wear of the upper bearing surface 88, the farther along the divert path 164 does the handoff back to the bearing surface occur. The follower 58 makes its way along the divert exit channel 156 guided by the upper diagonal exit guide wall 174 in contact with the follower's upper bearing surface 88, as shown in FIG. 11E.

The lower diagonal exit guide wall 172 contacts only the follower's pin 90. The follower's upper bearing surface 88 is at a level above the top of the lower diagonal exit guide wall 172, which is offset farther into the divert exit channel 156 than the upper diagonal exit guide wall 174. As shown in FIG. 11E, the offset produces a ledge 175 that extends from the upper diagonal exit guide wall 174 to the top of the lower diagonal exit guide wall 172. The resulting two-level guide structure with the handoff to and from guiding the lower pin 90 decreases the stroke of the actuator and the shuttle 140 from what it would have to be for a single-level guide structure for a follower without a bottom pin. And a decreased shuttle stroke between the divert and home positions accommodates greater belt speeds for greater throughput.

As best shown in FIG. 11B, the lower diagonal exit guide wall 172 extends downward from the ledge 175 to a floor 171 that is deep enough below the ledge to permit clear passage of the follower's pin 90 through the divert exit channel 156 of the diverter switch. Floors of the entry channel 146, the shuttle's gap 168, and the inline exit channel 154 are coplanar with the floor 171 of the divert exit channel 156.

FIG. 12 shows the contact handoff from a worn upper bearing surface 88′ of the follower 58 to the tapered segment of the side wall 93 of the pin 90. In contrast to FIG. 11B, the point of initial contact between the pin 90 and the lower diagonal exit guide wall 172 is closer to the start of the exit guide wall in the case of the worn bearing surface 88′. The tapering of the pin's side wall avoids snagging on a vertex 183 of the ledge 175. But if the combined wear of the follower's upper bearing surface 88′ and of the shuttle's diagonal wall 166 is great enough, the apex 84 of the pin 90 will become jammed on the side of the vertex 183 opposite the lower diagonal exit guide wall 172, and the handoff will fail.

FIGS. 10A and 10B show the shuttle 140 in a left-most position that guides the follower 58 along an inline path 176 keeping the follower in a fixed home position on the belt. The inline wall 170 on the shuttle 140 blocks the divert exit channel 156 and forms a continuation of the right entry channel wall 149. Because the divert exit channel 156 is blocked by shuttle structure, the follower 58 is confined to the inline path 176 in the direction of belt travel 52 by parallel upper inline walls 178, 179 in the guide portion 139 of the diverter switch 136. A ledge 169 skirting the left inline wall 178 has a chamfered corner 167 that extends down to the bottom of the home exit channel 154 to help prevent the pin 90 from snagging as it enters the guide portion 139. The right ledge 175 skirts the right inline wall 179 as well as a portion of the upper diagonal exit guide wall 174 and forms the vertex 183 adjacent to the exit from the shuttle 140. The right inline wall 179 and the upper diagonal exit guide wall 174 meet at an upper vertex 181 above the level of the lower vertex 183 and farther than the lower vertex from the shuttle 140.

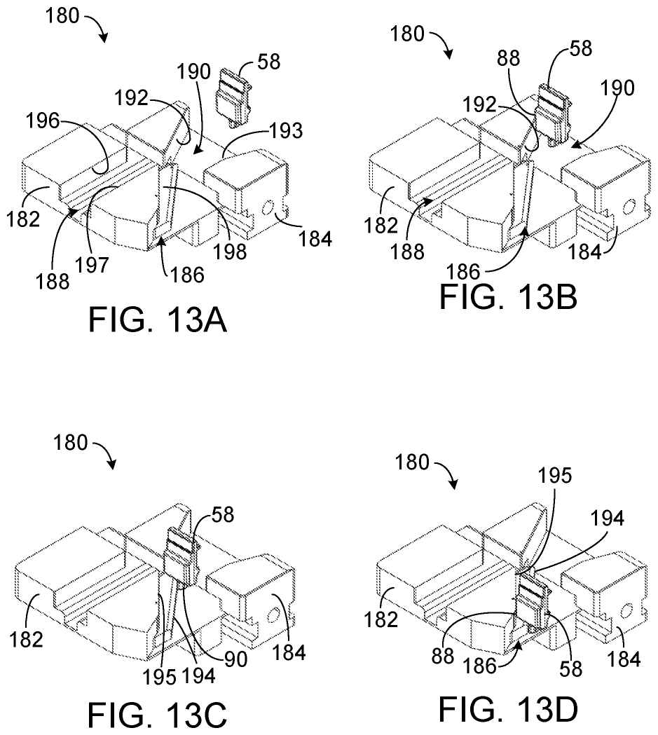

Another version of a diverter switch is shown in FIGS. 13A-13D showing the sequence of diverting the follower 58. The belt and slat are omitted for clarity. The diverter switch 180 has a fixed guide portion 182 and a translatable shuttle 184 as an entry portion of the switch. Like the shuttle 140 of FIG. 8, the shuttle 184 is translated laterally by a linear actuator (not shown, but equivalent to the actuator 144 of FIG. 8). The guide portion 182 has a divert exit channel 186 and an inline home exit channel 188. In this version, the divert exit channel 186 guides the follower 58 to the left side of the conveyor as opposed to the divert exit channel 156 in the switch 136 of FIG. 8, which guides the follower 58 to the right side of the conveyor. As such, the diverter switch 180 would typically be mounted near the right side, instead of the left side, of the conveyor. But the switch 180, like the switch 136, could be made in both left-and right-side versions.

The shuttle 184 in FIGS. 13A-13D is shown in the diverting position. The shuttle has an entry channel 190 with opposite walls 192, 193 that converge from a wide mouth to a narrower throat at the guide portion 182. In FIG. 13A the follower 58 is shown approaching the switch 180 in the home position. In FIG. 13B the follower 58 contacts the wall 192 of the shuttle's entry channel 190. The contact is with the follower's bearing surface 88. The diagonal wall 192 guides the follower 58 laterally toward the divert exit channel 186. The diagonal wall 192 also blocks the home exit channel 188. Passing to the guide portion 182 in FIG. 13C, the follower's pin 90 initially contacts a lower exit diagonal guide wall 194. While the pin 90 is being guided by the diagonal exit guide wall 194 along the divert exit channel 186, the follower's upper bearing surface 88 is out of contact with the guide portion 182. Because the lower exit diagonal guide wall 194 tapers toward an upper exit diagonal guide wall 195, the follower's upper bearing 88 eventually contacts the upper diagonal guide wall as the follower 58 nears the exit of the divert exit channel 186 as shown in FIG. 13D. Once that contact is made, the follower's pin 90 is out of contact with the lower exit diagonal guide wall 194.

To guide the follower 58 to the inline home exit channel 188, the actuator positions the shuttle 184 so that its walls 192, 193 are continuous with walls 196, 197 bounding the channel. In that way, the follower 58 is guided straight through the switch 180 in the direction of belt travel. Like the diverter switch 136 of FIG. 9A, the switch 180 has a similar two-level guide structure with a ledge 198.

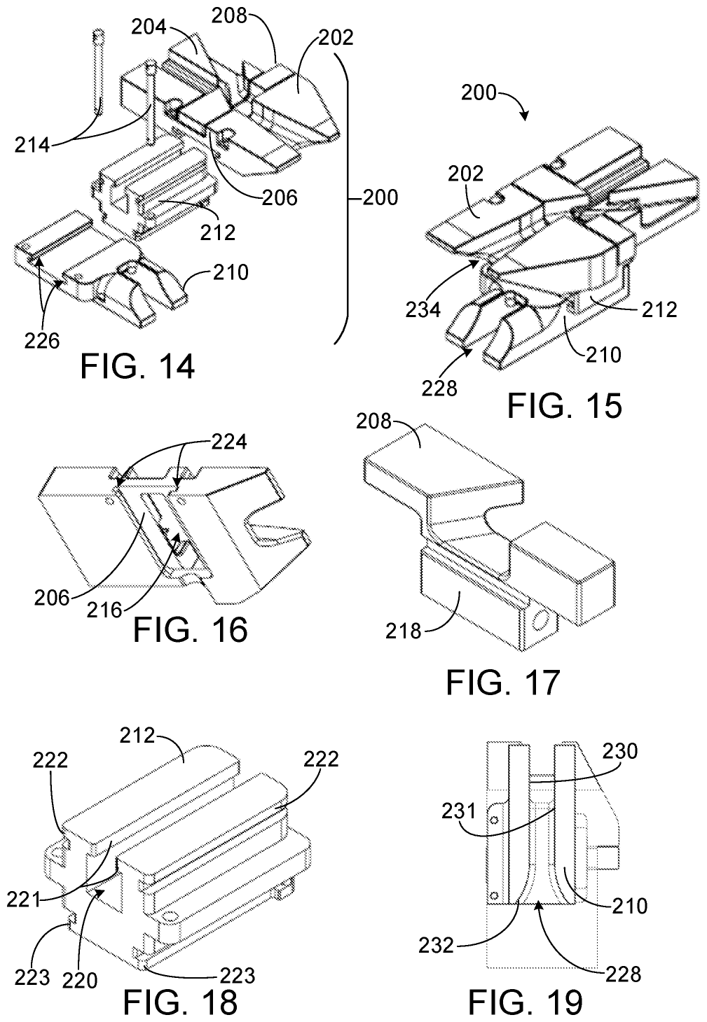

Another version of a diverter switch is shown in FIGS. 14 and 15. The diverter switch 200 includes an entry portion 202 monolithically formed with a guide portion 204 and joined by an intermediate portion 206 providing a race for a shuttle 208. An aligner 210 is connected to the intermediate portion 206 by a connection block 212. Locking pins 214 extend through the entry and guide portions 202, 204 and the connection block 212 into the aligner 210 to lock the pieces together in registration.

As shown in FIGS. 16-18, the intermediate portion 206 has an opening 216 though which a block 218 at the bottom of the shuttle 208 passes to be slidably received in a slot 220 in the connection block 212. Overhangs 221 over the slot 220 retain the shuttle block 218 in the slot. Upper and lower flanges 222, 223 at the top and bottom of the connection block 212 slide into grooves 224 in the intermediate portion 206 and grooves 226 (FIG. 14) in the aligner 210 to form connection joints between the pieces. The resulting switch stack 200 shown in FIG. 15 is mounted in the conveyor with the upper switch portion 202, 204, 206, 208 in the carryway and the aligner 210 in the returnway.

As shown in FIG. 19, the aligner 210 has an inline alignment channel 228 bounded by opposite alignment guide walls 230, 231. The walls are parallel along most of their length but diverge toward an entrance end 232 to provide a wide mouth that receives carrier followers returning precisely in the home position or slightly offset from the home position but not so far as to cause excessive wear between the follower and the entry portion 202 of the switch 200. The alignment guide walls 230, 231 ensure that the followers are returned to the precise home position to be received in the switch's entry channel 234. As shown in FIG. 15, the alignment channel 228 of the return aligner 210 and the entry channel 234 of the entry portion 202 are registered in vertical alignment by the connection block 212 to ensure that followers returning to the carryway are delivered in the home position to the entry portion 202 of the switch 200.

When the carriers 54 are being diverted as in FIG. 1 by their followers' contact with the diagonal guide 160 of FIG. 7, the force applied to the followers 58 tends to cause the carriers to twist, or rotate, counterclockwise about the followers. As shown in FIG. 5, the rib 66 at the bottom side 65 of the slat 56 sits in the groove 50 on the top 34 of the carrier module 26A. Because the torque on the carrier 54 due to the moving contact between the follower 58 and the diagonal guide 160 (FIG. 7) as the belt advances is transmitted through the rib 66 to the confining walls of the groove 50, the carrier's twist is limited.

Although the features of the invention have been described with respect to exemplary versions, other versions are possible. For example, a diverter switch having two divert exit channels on opposite sides of an inline home exit channel or two divert exit channels without an inline home exit channel. As another example, the diagonal guide doesn't have to be linear; it could be curved. And the term “oblique” isn't limited to “oblique at a constant angle”; the angle can vary. And the designations “left” and “right” are used in reference to the drawings as rendered with the home position to the left of the divert position. The home position on the conveyor could be to the right of the divert position with the diverter switch reversed and the inline, diagonal, and return guides accordingly repositioned.

What is claimed is:

1. A conveyor comprising:
a carryway;
a conveyor belt suitable for advancing along the carryway in a direction of belt travel, the conveyor belt comprising:
a series of belt rows of one or more belt modules hingedly joined end to end at hinge joints, wherein each of the belt rows extends in width from a first side to a second side and in thickness from a top to a bottom and at least some of the belt rows comprise:
a belt module that extends in width from a left side to a right side and includes:
a slot extending through the thickness of the belt module along the width of the belt module;
a carrier having:
a follower extending through the slot and past the bottom of the belt module and having a bearing surface;
a slat attached to the follower at the top of the belt module to slide along the width of the belt row with the follower and having an upper article-supporting surface and a bottom side;
wherein the slat extends along the width of the row;
an actuator;
a diverter switch in the carryway under the conveyor belt and including:
a guide portion having a first exit channel and a second exit channel oblique to the first exit channel;
a shuttle defining at least a portion of an entry channel that leads to the first and second exit channels and having a gap;
wherein the actuator is coupled to the shuttle to translate the shuttle from a first position in which the gap is positioned to define a first path for the carrier's follower through the entry channel, the gap, and the first exit channel and in which shuttle structure blocks the second exit channel to a second position in which the gap is positioned to define a second path for the carrier's follower through the entry channel, the gap, and the second exit channel and in which shuttle structure blocks the first exit channel.

2. The conveyor as claimed in claim 1 wherein the diverter switch includes a fixed entry portion defining a portion of the entry channel, wherein the shuttle is between the entry portion and the guide portion.

3. The conveyor as claimed in claim 1 wherein the shuttle defines the entire entry channel.

4. The conveyor as claimed in claim 1 wherein the first exit channel is an inline exit channel parallel to the direction of belt travel and wherein the second exit channel is a divert exit channel oblique to the direction of belt travel.

5. The conveyor as claimed in claim 4 wherein:
the follower has a follower body with a pin extending downward at the bottom of the follower body and wherein the pin is narrower than the rest of the follower body and is at a level below the level of the follower's bearing surface;
the guide portion has an upper diagonal exit guide wall bounding the divert exit channel and a lower diagonal exit guide wall bounding the divert exit channel closer to the shuttle's gap;
wherein, when the shuttle is in the second position, the pin, after exiting the gap, engages the lower diagonal exit guide wall to divert the follower into the divert exit channel where the bearing surface of the follower engages the upper diagonal exit guide wall to guide the follower the rest of the way through the diagonal exit channel along the second path.

6. The conveyor as claimed in claim 5 wherein the lower diagonal exit guide wall is offset farther into the divert exit channel than the upper diagonal exit guide wall.

7. The conveyor as claimed in claim 5 comprising a two-level guide structure including a ledge in the guide portion that extends from the upper diagonal exit guide wall to the top of the lower diagonal exit guide wall and wherein the follower's pin passing through the divert exit channel is below the level of the ledge and the rest of the follower body is above the level of the ledge.

8. The conveyor as claimed in claim 4 wherein the entry channel and the inline exit channel define a home position along the width of the conveyor and wherein the conveyor comprises a returnway and a return guide in the returnway that guides followers not in the home position back into the home position before they enter the diverter switch.

9. The conveyor as claimed in claim 4 comprising:
a home guide in the carryway extending in the direction of belt travel from the inline home exit channel of the diverter switch;
a diagonal guide in the carryway extending oblique to the direction of belt travel from the divert exit channel of the diverter switch;
wherein the home guide prevents the followers exiting the inline home exit channel from leaving a fixed home position along the width of the belt rows; and
wherein the diagonal guide guides the followers exiting the divert exit channel across the width of the belt rows.

10. The conveyor as claimed in claim 1 wherein the entry channel is bounded by two opposing walls that converge from a wide mouth to a narrower throat in the direction of belt travel.

11. A conveyor comprising:
a carryway;
a conveyor belt suitable for advancing along the carryway in a direction of belt travel, the conveyor belt comprising:
a series of belt rows of one or more belt modules hingedly joined end to end at hinge joints, wherein each of the belt rows extends in width from a first side to a second side and in thickness from a top to a bottom and at least some of the belt rows comprise:
a belt module that extends in width from a left side to a right side and includes:
a slot extending through the thickness of the belt module along the width of the belt module;
a carrier having:
a follower extending through the slot and past the bottom of the belt module and having a follower body having an upper bearing surface and a pin extending downward from a bottom of the follower body;
wherein the pin is narrower than the rest of the follower body and is disposed at a level lower than a lowermost level of the upper bearing surface;
a slat attached to the follower at the top of the belt module to slide along the width of the belt row with the follower and having an upper article-supporting surface;
wherein the slat extends along the width of the row;
an actuator;
a diverter switch in the carryway under the conveyor belt and including:
an entry portion having two side walls defining an entry channel through which the carrier's follower is guided by contact between the follower's upper bearing surface and one of the side walls;
a shuttle having a gap between two walls;
a guide portion having:
a first exit channel and a second exit channel oblique to the first exit channel;
an upper diagonal exit guide wall bounding the second exit channel and a lower diagonal exit guide wall bounding the second exit channel closer to the shuttle's gap;
wherein the actuator is coupled to the shuttle to translate the shuttle from a first position in which the gap is positioned to define a first path for the carrier's follower through the entry channel, the gap, and the first exit channel and in which shuttle structure blocks the second exit channel to a second position in which the gap is positioned to define a second path for the carrier's follower through the entry channel, the gap, and the second exit channel and in which shuttle structure blocks the first exit channel;
wherein, when the shuttle is in the second position, the follower is guided through the entry channel by contact between the upper bearing surface and one of the entry portion's side walls and one of the shuttle's walls and, after exiting the gap, by contact between the pin and the lower diagonal exit guide wall to divert the follower into the second exit channel until the upper bearing surface of the follower engages the upper diagonal exit guide wall to guide the follower the rest of the way through the second exit channel along the second path.

12. A diverter switch suitable for causing a conveyor belt's follower having an upper bearing surface and a recessed lower bearing surface to translate laterally along the width of the belt perpendicular to a direction of belt travel of the conveyor belt along an upper carryway and returning along a lower returnway, the diverter switch comprising:
a shuttle having a first diagonal wall and a second wall and being laterally translatable between a first position and a second position;
a fixed guide portion having first and second exit channels, wherein the second exit channel is bounded on one side by a lower exit guide wall and an upper exit guide wall at a level above the lower exit guide wall;
wherein, when the shuttle is in the second position, a conveyor-belt follower is initially guided laterally as the conveyor belt advances in a direction of belt travel by contact between an upper bearing surface of the follower and the first diagonal wall, then guided by contact between a lower bearing surface of the follower and the lower exit guide wall, and finally guided by contact between the upper bearing surface and the upper exit guide wall along the second exit channel.

13. The diverter switch as claimed in claim 12 wherein the first diagonal wall of the shuttle blocks the first exit channel when the shuttle is in the second position and wherein the second wall of the shuttle blocks the second exit channel when the shuttle is in the first position.

14. The diverter switch as claimed in claim 12 wherein the first exit channel is parallel to the direction of belt travel.

15. The diverter switch as claimed in claim 12 comprising:
a fixed entry portion separated from the fixed guide portion by the shuttle and having an entry channel parallel to the direction of belt travel;
an aligner connected to the fixed entry and guide portions and having an alignment channel parallel to the direction of belt travel;
wherein the fixed entry and guide portions and the shuttle are disposed in the upper carryway and the aligner is disposed in the lower returnway so that the alignment channel is vertically aligned with the entry channel to ensure that the follower returns to the entry channel from the returnway.

16. The diverter switch as claimed in claim 15 comprising a connection block connecting the fixed entry and guide portions to the aligner to maintain the entry channel and the alignment channel in registration.

17. The diverter switch as claimed in claim 12 wherein the first and second exit channels are each bounded by a lower wall that extends upward from a floor to a ledge that extends from the top of the lower wall to the bottom of an upper wall.
